(19) United States
(12) Patent Application Publication
(10) Pub. No.: US 2014/0117896 A1
(43) Pub. Date: May 1, 2014

(54) APPARATUS AND METHOD FOR MOTOR DRIVING CONTROL AND MOTOR USING THE SAME

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/772,106

(22) Filed: Feb. 20, 2013

(30) Foreign Application Priority Data
Oct. 30, 2012 (KR) 10-2012-0121230

(51) Int. Cl. H02P 6/20

(52) U.S. Cl. CPC H02P 6/20
USPC 318/400.11

(57) ABSTRACT

There are provided an apparatus and method for motor driving control, and a motor using the same. The motor driving control apparatus according to an embodiment of the present invention includes a driving circuit unit providing an initial driving control signal of a motor; a current detection unit detecting initial driving current generated by the initial driving control signal; and a control unit determining that back-electro motive force is generated when the initial driving current decreases to a preset critical value or below and controlling the motor to be normally driven.

### CROSS-REFERENCE TO RELATED APPLICATIONS

This application claims the priority of Korean Patent Application No. 10-2012-0121230 filed on Oct. 30, 2012, in the Korean Intellectual Property Office, the disclosure of which is incorporated herein by reference.

### BACKGROUND OF THE INVENTION

1. Field of the Invention

The present invention relates to an apparatus and method for motor driving control capable of rapidly performing initial motor driving by sensing a motor driving current to determine an initial driving state of the motor, and a motor using the same.

2. Description of the Related Art

In general, in accordance with the continuing development of motor technology, motors of various sizes are used in a wide range of technological fields.

Generally, a motor is driven by rotating a rotor using a permanent magnet and a coil in which a polarity is altered according to induced current. Initially, a brush motor having a configuration in which a rotor includes a coil has been used, but in this case, a brush may be worn or sparks may be generated by the driving of the motor.

Therefore, recently, brushless motors having various shapes have been commonly used. In the brushless motor, a permanent magnet is used as a rotor, and a plurality of coils are provided in a stator, thereby inducing rotation of the rotor.

In the case of a brushless motor, a position of the rotor should be confirmed. To this end, a scheme of using back-electro motive force (BEMF) has been widely used.

However, in the case in which initial driving of the motor is performed in a lock mode, since the back-electro motive force may not be instantly detected, there may be a limitation in driving. That is, since excessive driving force is required until back-electro motive force is generated, there are limitations in that durability of the motor may be deteriorated, and the initial driving thereof may not be rapidly performed.

The following related art documents relate to this brushless motor, but do not disclose a technology for overcoming these initial driving limitations due to back-electro motive force.

### RELATED ART DOCUMENT

(Patent Document 1) Korean Patent No. 10-1087581
(Patent Document 2) Korean Patent Laid-Open Publication No. 2012-0079375

### SUMMARY OF THE INVENTION

An aspect of the present invention provides an apparatus and method for motor driving control capable of rapidly performing initial motor driving, without detecting back-electro motive force, by sensing a motor driving current to determine an initial driving state of the motor, and a motor using the same.

According to an aspect of the present invention, there is provided a motor driving control apparatus including: a driving circuit unit providing an initial driving control signal of a motor; a current detection unit detecting initial driving current generated by the initial driving control signal; and a control unit determining that back-electro motive force is generated when the initial driving current decreases to a preset critical value or below and controlling the motor to be normally driven.

The motor driving control apparatus may further include an inverter unit applying phase voltage to the motor according to the initial driving control signal, and the current detection unit may detect the initial driving current from the inverter unit.

The motor driving control apparatus may further include a back-electro motive force detection unit detecting the back-electro motive force generated from the motor.

The control unit may control a rotor of the motor using the back-electro motive force detected by the back-electro motive force detection unit when the motor is normally driven.

The control unit may include: a lock mode controller determining whether or not a lock mode is set; and a duty controller differentially controlling a duty according to whether or not the lock mode is set.

The lock mode controller may release the lock mode when the initial driving current exceeds the critical value and then decreases to the critical value or below.

The duty controller may control the driving circuit unit to generate an initial driving control signal having a preset duty or more when the lock mode is set.

The duty controller may control the driving circuit unit to generate a normal driving signal corresponding to a pre-requested duty when the lock mode is released.

According to another aspect of the present invention, there is provided a motor including: a brushless motor apparatus including a plurality of coils spaced apart from each other at the same angle; and a motor driving control apparatus capable of independently controlling a plurality of phases corresponding to the plurality of coils, wherein the motor driving control apparatus includes: a driving circuit unit providing an initial driving control signal of the motor; a current detection unit detecting initial driving current generated by the initial driving control signal; and a control unit determining that back-electro motive force is generated when the initial driving current decreases to a preset critical value or below and controlling the motor to be normally driven.

According to another aspect of the present invention, there is provided a motor driving control method performed by a motor driving control apparatus controlling driving of a brushless motor, the motor driving control method including: applying an initial driving duty having a preset duty or more; detecting initial driving current generated in an inverter unit by the initial driving duty; and applying a normal driving duty rather than the initial driving duty when the detected initial driving current has a preset critical value or below.

The applying of the initial driving duty may include: confirming whether the motor is in a lock mode; and continuously applying the initial driving duty having the preset duty or more when the motor is in the lock mode.

The applying of the driving duty may include: confirming whether the initial driving current exceeds the preset critical value; and confirming whether the initial driving current decreases to the critical value or below after the initial driving current exceeds the critical value.

The applying of the driving duty may further include determining that back-electro motive force is generated in the motor when the initial driving current decreases to the critical value or below to apply the normal driving duty.

The applying of the driving duty may include detecting back-electro motive force generated in the motor to generate the driving duty using the detected back-electro motive force.

The applying of the driving duty may include: detecting back-electro motive force in each of the plurality of phases of the motor; and providing driving current to a coil corresponding to a phase having the highest back-electro motive force.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram describing an example of a motor driving control apparatus of a general brushless motor;

FIG. 2 is a reference diagram describing a motor driving control method of a general brushless motor;

FIG. 3 is a reference diagram describing a signal for driving of a general brushless motor;

FIG. 4 is a configuration diagram describing an example of a motor driving control apparatus according to an embodiment of the present invention;

FIG. 5 is a flowchart describing an example of a motor driving control method according to an embodiment of the present invention;

FIG. 6 is a detailed flowchart describing an example of S530 of FIG. 5; and

FIG. 7 is a reference diagram describing a signal for motor driving according to an embodiment of the present invention.

### DETAILED DESCRIPTION OF THE EMBODIMENTS

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like elements.

A brushless motor, a direct current (DC) motor driven using an electronic rectifier rather than using a mechanical contact such as a brush, a commutator, or the like, may include a rotor formed of a permanent magnet and a 3-phase or 4-phase coil, such that the rotor may rotate according to a phase voltage of each coil.

In order to efficiently drive this brushless motor, commutation of respective phases (coil) of the rotor needs to be performed at the right time, and a position of the rotor needs to be recognized for appropriate commutation.

A position of the rotor may be detected using a device such as a hall sensor, a resolver, or the like. However, in this case, a driving circuit may become complicated. Therefore, a motor driving control apparatus for driving the brushless motor without a sensor has been used.

Hereinafter, embodiments of the present invention will be described in detail based on a sensorless brushless motor.

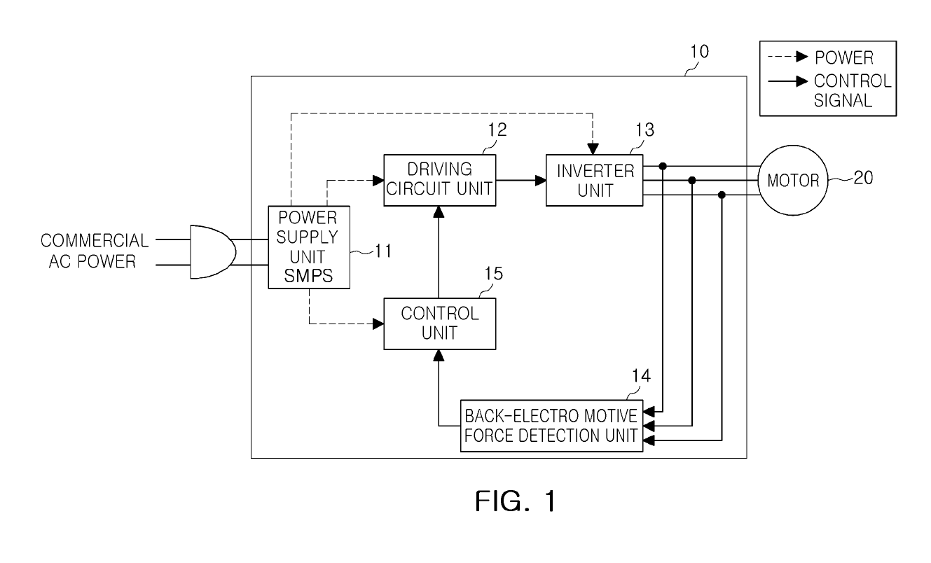

FIG. 1 is a configuration diagram describing an example of a motor driving control apparatus of a general brushless motor.

Referring to FIG. 1, a motor driving control apparatus 10 may convert commercial alternating current (AC) voltage into direct current (DC) voltage through a power supply unit 11 and convert the DC voltage into a plurality of phase (for example, three or four) voltages in an inverter unit 13 to apply the converted phase voltages to respective coils (not shown) of a brushless motor 20. Current flowing in each phase by the three phase voltage may generate a magnetic field in each coil of the motor 20, and a rotor (not shown) provided in the motor 20 may be rotated by the magnetic field.

In the case in which the motor 20 rotates as described above, back-electro motive force may be generated in the coil provided in the rotor of the motor 20, and a back-electro motive force detection unit 14 may detect the back-electro motive force generated in each coil of the brushless motor 20 to provide the detected signal to a control unit 15.

The control unit 15 may analyze the back-electro motive force detection signal provided from the back-electro motive force detection unit 14 to control an inverter driving circuit unit 12 so that the motor 20 is optimally operated, and the inverter driving circuit unit 12 may switch on the inverter unit 13 to adjust the phase voltage applied to the brushless motor 20.

More specifically, the back-electro motive force may be generated in a coil to which the phase voltage is not applied among the plurality of coils, and the control unit 15 may detect and provide the back-electro motive force through the back-electro motive force detection unit 14. The control unit 15 may recognize a zero cross point-EMF appearing whenever a zero phase of common point of the plurality of coils and the back-electro motive force (back-EMF) cross each other, and drive the inverter unit 13 based on the cross points.

That is, in the brushless motor 20, when the base-electro motive force is high, a torque of the motor becomes highest. Therefore, in the case in which current is applied to a coil corresponding to a phase having the highest back-electro motive force, the motor may be most efficiently driven. Therefore, the control unit 15 may control the driving circuit unit 12 so that the commutation is performed at a point at which the phase is lagged by about 30 degrees from a zero cross point of a distribution curve of the back-electro motive force detected from each coil.

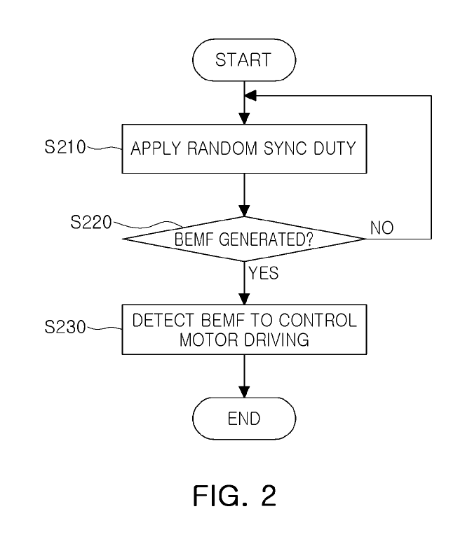

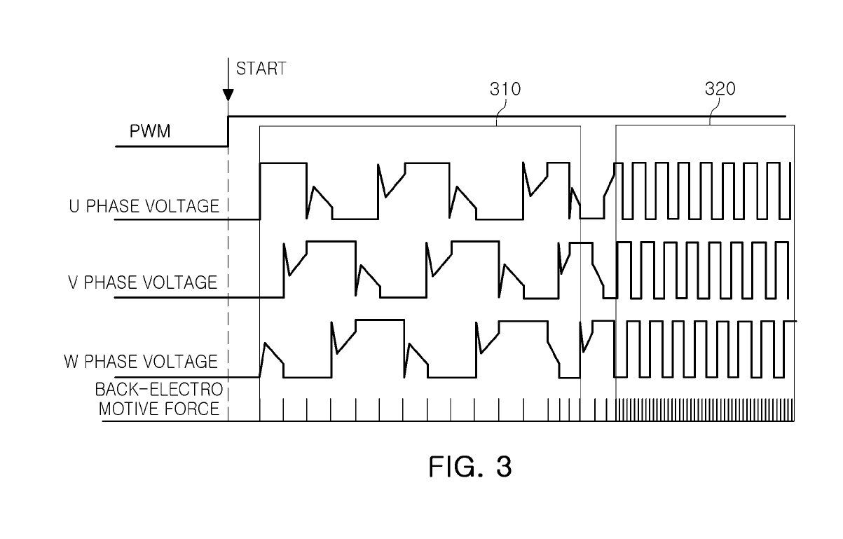

FIG. 2 is a reference diagram describing a motor driving control method of a general brushless motor, and FIG. 3 is a reference diagram describing an applied signal for driving of a general brushless motor. Hereinafter, referring to FIGS. 2 and 3, driving of the brushless motor, particularly an initial driving operation, will be described.

The control unit 15 may generate a random sync signal to apply the generated sync signal (S210).

The sync signal, a pulse width modulation (PWM) signal having a duty value of 100%, may be applied to respective coils at different voltages. The phase voltage applied to each coil may have a random value. The sync signal may be applied for a sufficient amount of time to sufficiently generate the back-electro motive force of the motor 20.

An example of the sync signal may be represented by reference number 310 in FIG. 3.

Thereafter, when back-electro motive force (BEMF) is generated (S220), the driving of the motor 20 may be controlled using the generated back-electro motive force as described above (S230).

That is, as shown in reference number 320 in FIG. 3, it may be appreciated that when the back-electro motive force starts to be detected, an initial driving operation is completed, and driving control for actual motor driving is performed.

However, in the case of the driving control as described above, 100% duty needs to be applied for a predetermined time or longer, in order to allow sufficient back-electro motive force to be detected, a considerable amount of time may be consumed.

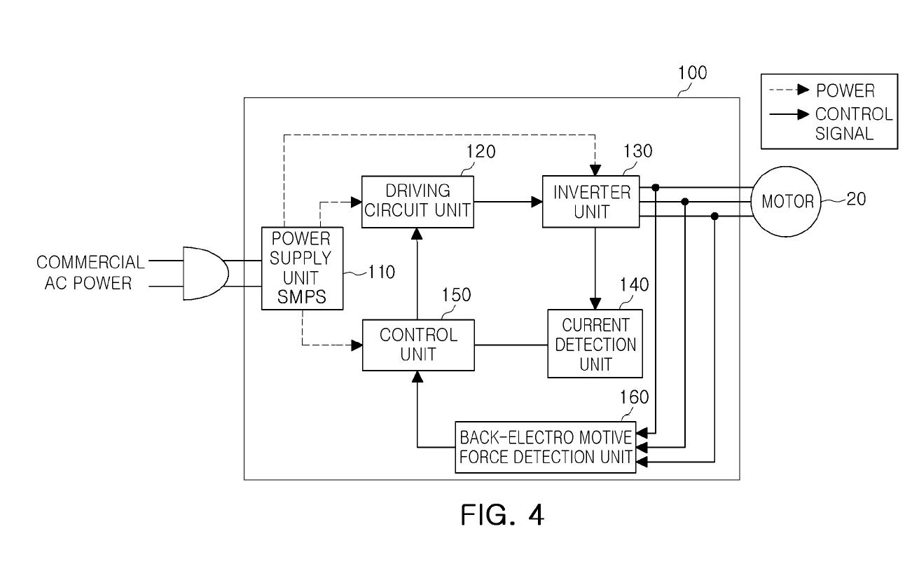

Hereinafter, referring to FIGS. 4 through 7, various embodiments of the present invention will be described.

Descriptions of various embodiments of the present invention to be provided below, overlapped descriptions the same as or corresponding to those provided with reference to FIGS. 1 though 3 will be omitted. However, those skilled in the art may clearly understand detailed contents of the present invention from the above-mentioned description.

In addition, hereinafter, terms “initial driving” and “driving” will be used as having meanings distinguished from each other. That is, the “initial driving state” refers to a state before the motor in a stopped state is actually controlled, and the “driving state” refers to a state after the motor is actually controlled.

According to the embodiment of the present invention, whether the motor 20 is in the initial driving state or in the driving state may be determined using a relationship between the back-electro motive force and current. That is, an amplitude of current in the initial driving state increases continuously until it becomes a predetermined value, and thus when the motor 20 is actually driven, the amplitude of current decreases. That is, when the motor 20 is driven, the current decreases. Therefore, according to the embodiment of the present invention, when the current decreases to a preset critical value or below, it may be determined that the motor is in a normal rotating state. In this normal rotating state (driving state), it may be determined that the back-electro motive force is generated.

That is, according to the embodiment of the present invention, even in the case that the back-electro motive force is generated at a level insufficient to control the motor 20, the case in which the current decreases to the critical value or below may be determined as the normal operation, and thus, the driving control may be performed.

FIG. 4 is a configuration diagram describing an example of a motor driving control apparatus according to an embodiment of the present invention.

Referring to FIG. 4, a motor driving control apparatus 100 may include a power supply unit 110, a driving circuit unit 120, an inverter unit 130, aback-electromotive force detection unit 160, a control unit 150, and a current detection unit 140.

The driving circuit unit 120 may provide an initial driving control signal to the motor 20. Here, the initial driving control signal is applied when the motor 20 is in a stopped state. In the embodiment, the initial driving control signal may be a control signal (for example, a PWM signal with 100% duty) having a duty of a preset value or more.

The inverter unit 130 may apply a phase voltage to the motor 20 according to the initial driving control signal.

The back-electro motive force detection unit 160 may detect back-electro motive force generated in the motor 20.

The current detection unit 140 may detect initial driving current generated by the initial driving control signal. For example, the current detection unit 140 may detect the initial driving current from the inverter unit 130.

The control unit 150 may determine that the back-electro motive force is generated when the initial driving current decreases to the preset critical value or below to control the motor to be normally driven.

In the embodiment, when the motor is normally driven, the control unit 150 may control a rotor (not shown) of the motor using the back-electro motive force detected by the back-electro motive force detection unit 160.

In the embodiment, the control unit 150 may control the driving of the motor 20 using a lock mode setting. Here, “lock mode” refers to a state in which the motor 20 is stopped. Therefore, the control unit 150 may perform the initial driving control in the lock mode state.

In more detail, the control unit 150 may include a lock mode controller determining whether or not the lock mode is set and a duty controller controlling the duty differentially according to whether or not the lock mode is set.

In the embodiment, in the case in which the initial driving current exceeds the critical value and then decreases to the critical value or below, the lock mode controller may release the lock mode.

In the embodiment, when the lock mode is set, the duty controller may control the driving circuit unit 120 to generate an initial driving control signal having a preset duty or more.

In the embodiment, when the lock mode is released, the duty controller may control the driving circuit unit 120 to generate a normal driving signal corresponding to the pre-requested duty.

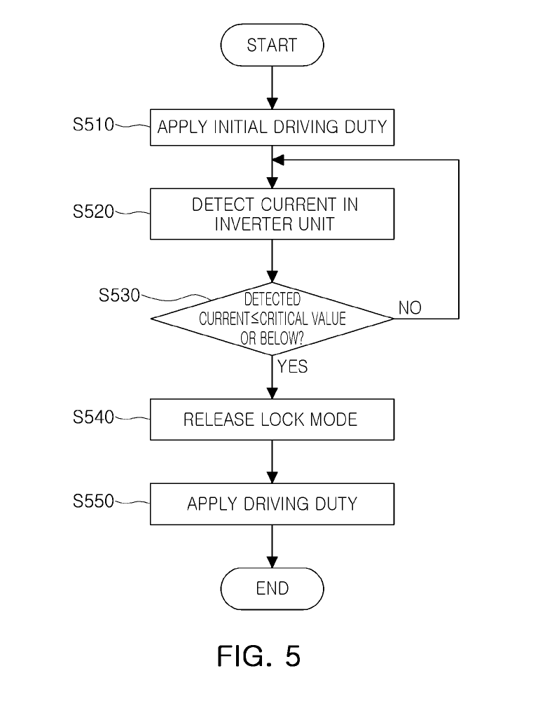

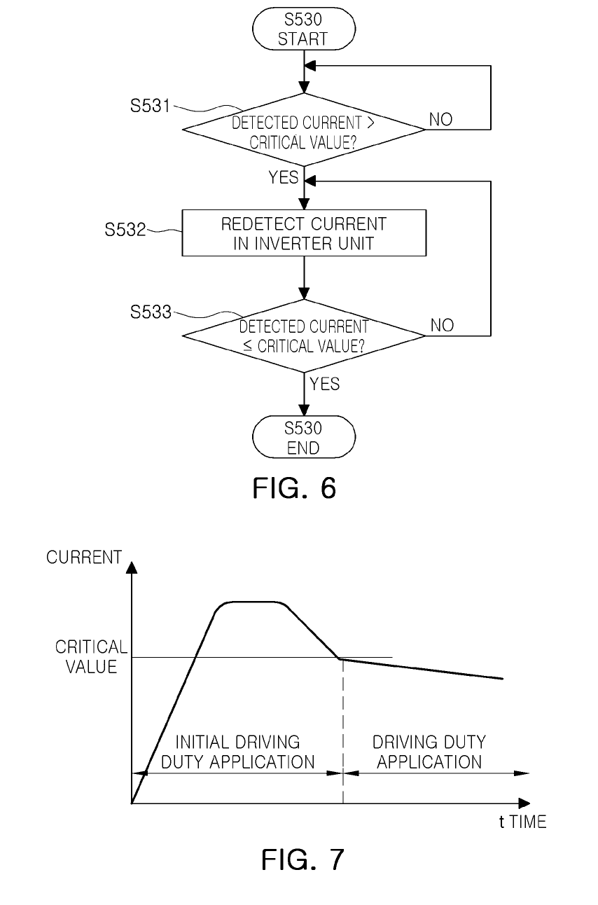

FIG. 5 is a flowchart describing an example of a motor driving control method according to an embodiment of the present invention, and FIG. 6 is a detailed flowchart describing an example of S530 of FIG. 5.

Hereinafter, referring to FIGS. 5 and 6, the motor driving control method according to the embodiment of present invention will be described. Since the motor driving control method according to the embodiment of the present invention is performed by the above-described motor driving control apparatus 100, overlapped descriptions the same as or corresponding to those described above will be omitted.

Referring to FIG. 5, the motor driving control apparatus 100 may apply an initial driving duty having a preset duty or more (S510).

The motor driving control apparatus 100 may detect initial driving current generated in the inverter unit by the initial driving duty (S520), and when the detected initial driving current has a preset critical value or below (‘YES’ in S530), the motor driving control apparatus 100 may apply a normal driving duty rather than the initial driving duty (S540 or S550).

On the contrary, when the detected initial driving current exceeds the preset critical value (‘NO’ in S530), the motor driving control apparatus 100 may continuously detect the initial driving current generated in the inverter unit (S520).

In the embodiment, the motor driving control apparatus 100 may determine whether or not the motor is in the lock mode to apply the initial driving duty.

In more detail, the motor driving control apparatus 100 may confirm whether the motor 20 is in the lock mode, and continuously apply the initial driving duty having the preset duty or more when the motor 20 is in the lock mode.

In the embodiment, the motor driving control apparatus 100 may confirm whether the current exceeds the critical value and then decreases to the critical value or below to apply the driving duty (See FIG. 6).

In more detail, the motor driving control apparatus 100 may confirm whether the initial driving current exceeds the preset critical value (S531), and when the initial driving current exceeds the present critical value, the motor driving control apparatus may redetect the current of the inverter unit (S532). When the current of the inverter unit, that is, the initial driving current is redetected, the motor driving control apparatus 100 may confirm whether the redetected initial driving current decreases to the critical value or below (S532).

According to the embodiment of the present invention, in a state in which the current does not exceed the critical value, the motor may be prevented from being changed to the driving state.

In addition, in the case in which the initial driving current decreases to the critical value or below, the motor driving control apparatus 100 may determine that back-electro motive force is generated in the motor 20 to apply the normal driving duty.

In the embodiment, the motor driving control apparatus 100 may detect the back-electro motive force generated in the motor 20 to generate the driving duty using the detected back-electro motive force. For example, the motor driving control apparatus 100 may detect the back-electro motive force in each of the plurality of phases of the motor 20 and provide the driving current to a coil corresponding to a phase having the highest back-electro motive force.

FIG. 7 is a reference diagram describing an applied signal for motor driving according to an embodiment of the present invention.

FIG. 7 shows that current increases continuously in an initial driving state, and then the current gradually decreases while the motor 20 is driven. Therefore, as described above, according to the embodiment of the present invention, it may be appreciated that initial driving control is performed by an initial driving duty (for example, 100% duty) until the current decreases to a critical value or below, and driving control is performed by a driving duty (a duty value desired for driving) when the current decreases to the critical value or below.

As set forth above, according to embodiments of the present invention, initial motor driving may be rapidly performed, without detecting back-electro motive force, by sensing a motor driving current to determine an initial driving state of the motor.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a driving circuit unit providing an initial driving control signal of a motor;
a current detection unit detecting initial driving current generated by the initial driving control signal; and
a control unit determining that back-electro motive force is generated when the initial driving current decreases to a preset critical value or below and controlling the motor to be normally driven.

2. The motor driving control apparatus of claim 1, further comprising an inverter unit applying phase voltage to the motor according to the initial driving control signal,
wherein the current detection unit detects the initial driving current from the inverter unit.

3. The motor driving control apparatus of claim 1, further comprising a back-electro motive force detection unit detecting the back-electro motive force generated from the motor.

4. The motor driving control apparatus of claim 3, wherein the control unit controls a rotor of the motor using the back-electro motive force detected by the back-electro motive force detection unit when the motor is normally driven.

5. The motor driving control apparatus of claim 1, wherein the control unit includes:
a lock mode controller determining whether or not a lock mode is set; and
a duty controller differentially controlling a duty according to whether or not the lock mode is set.

6. The motor driving control apparatus of claim 5, wherein the lock mode controller releases the lock mode when the initial driving current exceeds the critical value and then decreases to the critical value or below.

7. The motor driving control apparatus of claim 5, wherein the duty controller controls the driving circuit unit to generate an initial driving control signal having a preset duty or more when the lock mode is set.

8. The motor driving control apparatus of claim 5, wherein the duty controller controls the driving circuit unit to generate a normal driving signal corresponding to a pre-requested duty when the lock mode is released.

9. A motor comprising:
a brushless motor apparatus including a plurality of coils spaced apart from each other at the same angle; and
a motor driving control apparatus capable of independently controlling a plurality of phases corresponding to the plurality of coils,
wherein the motor driving control apparatus includes:
a driving circuit unit providing an initial driving control signal of the motor;
a current detection unit detecting initial driving current generated by the initial driving control signal; and
a control unit determining that back-electro motive force is generated when the initial driving current decreases to a preset critical value or below and controlling the motor to be normally driven.

10. A motor driving control method performed by a motor driving control apparatus controlling driving of a brushless motor, the motor driving control method comprising:
applying an initial driving duty having a preset duty or more;
detecting initial driving current generated in an inverter unit by the initial driving duty; and
applying a normal driving duty rather than the initial driving duty when the detected initial driving current has a preset critical value or below.

11. The motor driving control method of claim 10, wherein the applying of the initial driving duty includes:
confirming whether the motor is in a lock mode; and
continuously applying the initial driving duty having the preset duty or more when the motor is in the lock mode.

12. The motor driving control method of claim 10, wherein the applying of the driving duty includes:
confirming whether the initial driving current exceeds the preset critical value; and
confirming whether the initial driving current decreases to the critical value or below after the initial driving current exceeds the critical value.

13. The motor driving control method of claim 12, wherein the applying of the driving duty further includes determining that back-electro motive force is generated in the motor when the initial driving current decreases to the critical value or below to apply the normal driving duty.

14. The motor driving control method of claim 10, wherein the applying of the driving duty includes detecting back-electro motive force generated in the motor to generate the driving duty using the detected back-electro motive force.

15. The motor driving control method of claim 14, wherein the applying of the driving duty includes:
detecting back-electro motive force in each of the plurality of phases of the motor; and
providing driving current to a coil corresponding to a phase having the highest back-electro motive force.
